(19) United States
(12) Patent Application Publication
(10) Pub. No.: US 2014/0125154 A1
(43) Pub. Date: May 8, 2014

(54) POLY GAP TRANSVERSE FLUX MACHINE

(71) Applicant: Kress Motors, LLC, Ligonier, PA (US)

(72) Inventors: Timm A. Vanderelli, Ligonier, PA (US); Rodney A. Carter, Buchanan, TN (US); Keith Klontz, Seminole, FL (US); Haodong Li, Seminole, FL (US)

(21) Appl. No.: 14/153,629

(22) Filed: Jan. 13, 2014

Related U.S. Application Data
(63) Continuation-in-part of application No. 13/837,141, filed on Mar. 15, 2013.
Application No. 13/837,141 is a continuation-in-part of application No. 13/397,121, filed on Feb. 15, 2012.
Application No. 13/397,121 is a continuation-in-part of application No. 12/975,652, filed on Dec. 22, 2010, now Pat. No. 8,138,696.
(60) Provisional application No. 61/288,938, filed on Dec. 22, 2009.

(51) Int. Cl. H02K 1/22; H02K 11/00; H02K 1/02

(52) U.S. Cl. CPC H02K 1/22; H02K 1/02; H02K 11/0015
USPC 310/44; 310/68 B; 310/46

(57) ABSTRACT

The present invention relates to an improved electric machine which, when operating in motor mode, produces rotational torque without using alternating magnetic polarity, but rather magnetic flux that utilizes coils arranged in a dipolar manner around an axial plane and independently removable stators.

### CROSS-REFERENCE TO RELATED APPLICATIONS

This application is a continuation-in-part application of U.S. patent application Ser. No. 13/837,141 filed on Mar. 15, 2013.

### BACKGROUND

The present invention is an improvement over various attempts to increase the efficiency of electric machines. Examples of these attempts are set forth below:
U.S. Pat. No. 6,392,370, Bedini, Device and Method of a Back EMF Permanent Magnet Electromagnetic Motor;
U.S. Pat. No. 7,230,358, Smith, DC Resonance Motor;
U.S. Pat. No. 7,459,822, Johnson, Rotating Electric Machine Having Switched or Variable Reluctance with Flux Transverse to the Axis of Rotation; and
US Patent application 2009/0045690, Kerlin, DC Homopolar Motor/Generator.

Also see the following articles published in IEEE Transactions of Vehicular Technology, Vol. 55, No. 6, November 2006: Electric Motor Drive Selection Issues for HEV Propulsion Systems: A Comparative Study, written by: Mounir Zeraoulia, Mohamed El Hachemi Benbouzid, Demba Diallo; A Design of Axial-gap Switched Reluctance Motor for In-Wheel Direct-Drive EV, written by: Tohru Shibamoto, Kenji Nakamura, Hiroki Goto and Osamu Ishinokura of the Elec. And Comm. Eng. Dept., Tohoku University: and Design Procedure for Low Cost, Low Mass, Direct Drive, In-Wheel Motor Drivetrains for Electric and Hybrid Vehicles, written by: Howard C. Lovatt, Darrell Elton, Laurence Cahill, Duc Hau Huynh, Alex Stumpf, Ambarish Kulkarni, Ajay Kapoor, Mehran Ektesabi, Himani Mazumder, Thomas Dittmar, and Gary White.

### SUMMARY OF THE INVENTION

The present invention is an efficient poly gap transverse flux electric machine. It can be embodied in various form factors for use in a variety of applications and requires no magnets. In a presently preferred embodiment of invention, a stator member comprises a plurality of removable stator elements that are concentrically positioned around and spaced apart from the drive shaft of the motor. A rotor member is positioned on each end of the drive shaft parallel to the stator member. In one embodiment, a small fan is mounted on the shaft concentrically within the stator. In another embodiment of the invention, a third rotor member is positioned on the shaft concentrically within the stator elements.

### DESCRIPTION OF THE FIGURES

FIG. 1 is a perspective exploded view of the stator housing and a pair of rotors mounted on a drive shaft and having a fan mounted the drive shaft therebetween to cool the stator elements in a basic transverse circumferential flux machine of the present invention;

FIG. 2 is a perspective view the motor with a stator element depicted as being removed from the transverse circumferential flux machine depicted in FIG. 1;

FIG. 2a is an enlarged view of a stator element removed from stator housing as shown in FIG. 2;

FIG. 3 is a perspective exploded view of the structure of one of the two end rotors of the motor shown in FIG. 1;

FIG. 4 is a block diagram of the electrical drive circuits for the assembled motor shown in FIG. 1; and

FIG. 5 is an exploded perspective view of another embodiment of the machine shown in FIGS. 1 and 2 in which three separate rotor elements are mounted on the drive shaft and concentrically positioned within the core of the stator elements for concentric rotation therewithin.

### DESCRIPTION OF PREFERRED EMBODIMENTS

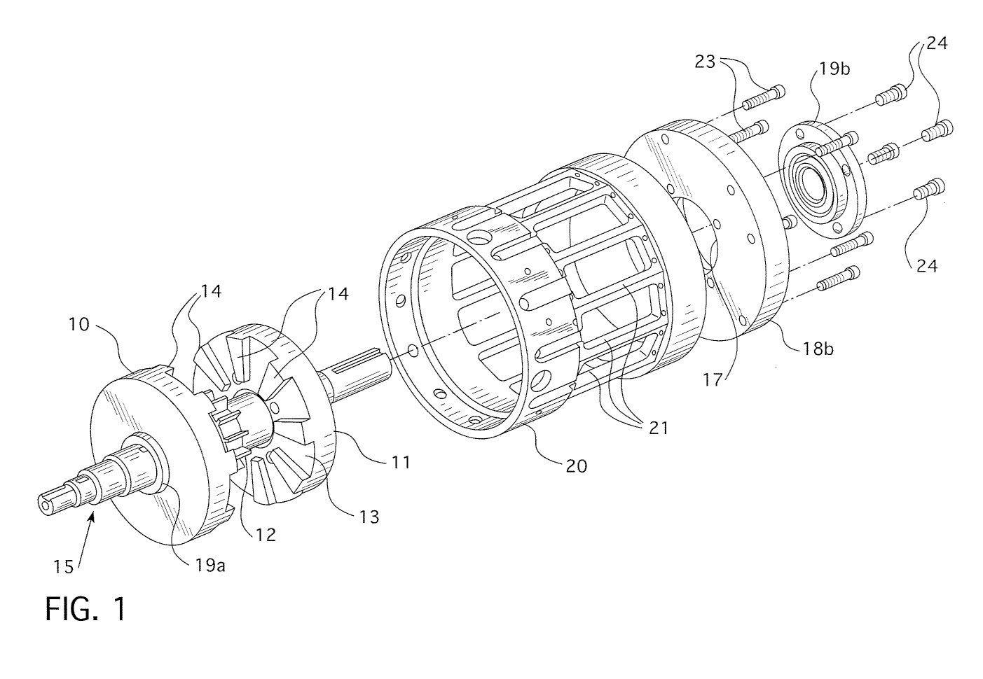

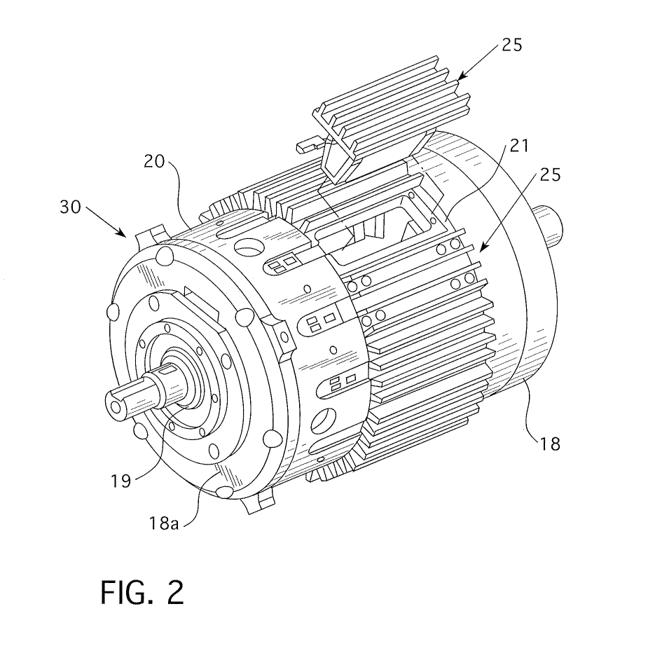

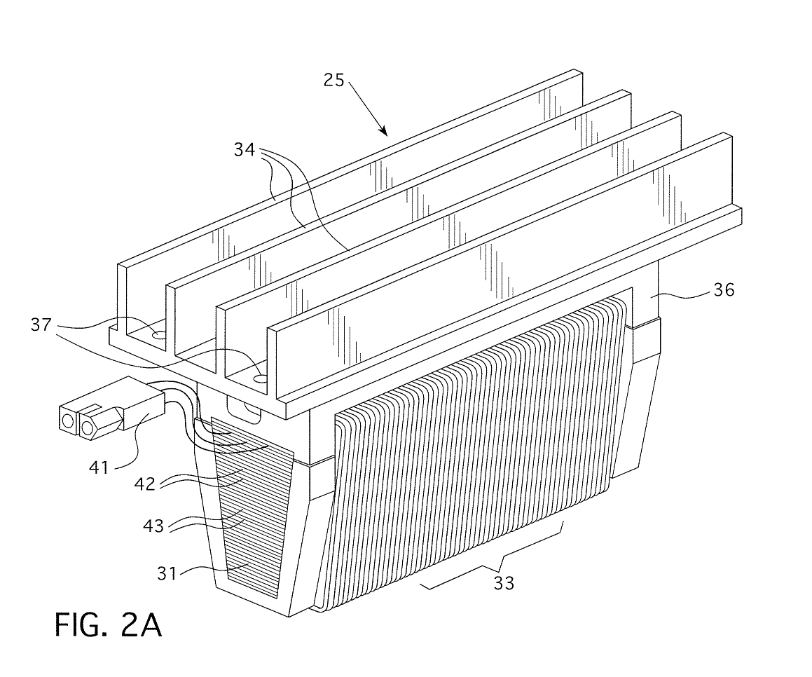

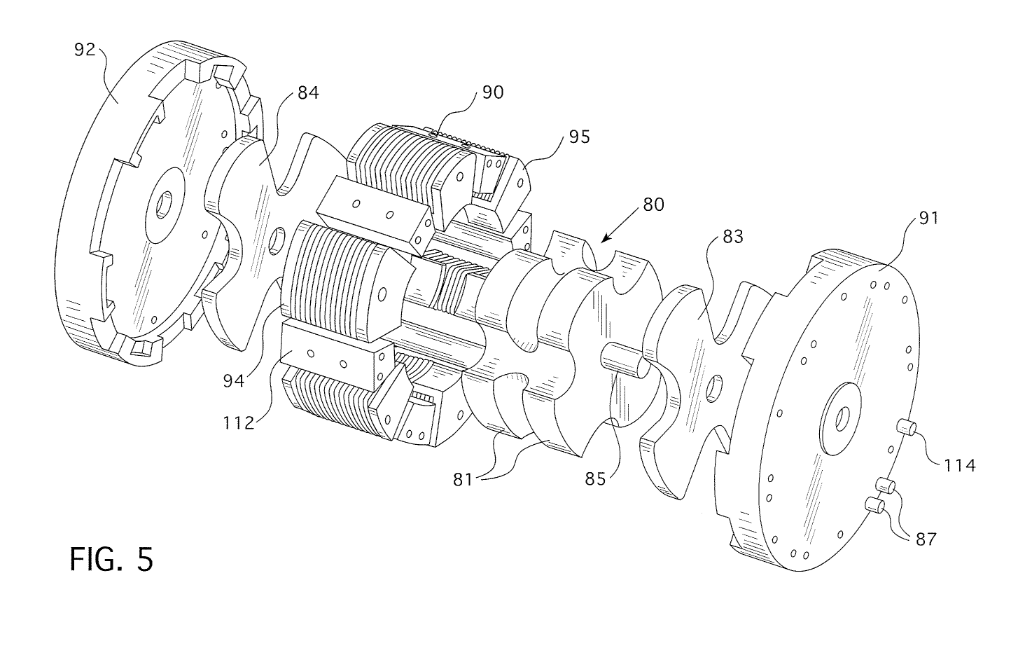

Referring to FIG. 1, an exploded, perspective view of rotor members 10 and 11, respectively, of motor 30 which is more completely depicted in FIG. 2. Each rotor 10 and 11 is mounted to drive shaft 15 at its respective ends. As shown in FIG. 1, a small stirring fan 12 is shown mounted between rotors 10 and 11 and within the center of the stator members 25. A small air circulating stirring fan 12 is used to cool stators members 25 shown in FIG. 2. In another embodiment, additional rotor members can be placed on drive shaft 15 as shown in FIG. 5 where they are located concentrically within and spaced apart from the stator member assembly itself. Rotor members 10 and 11 are spiral wound. The spiral windings or rotors are discs made from a spiral wrap of magnetically permeable tape or strip comprise a plurality of rotor poles 14 are formed on the planar surfaces of the discs by cutting and forming notches 13 between the extending pole faces 14.

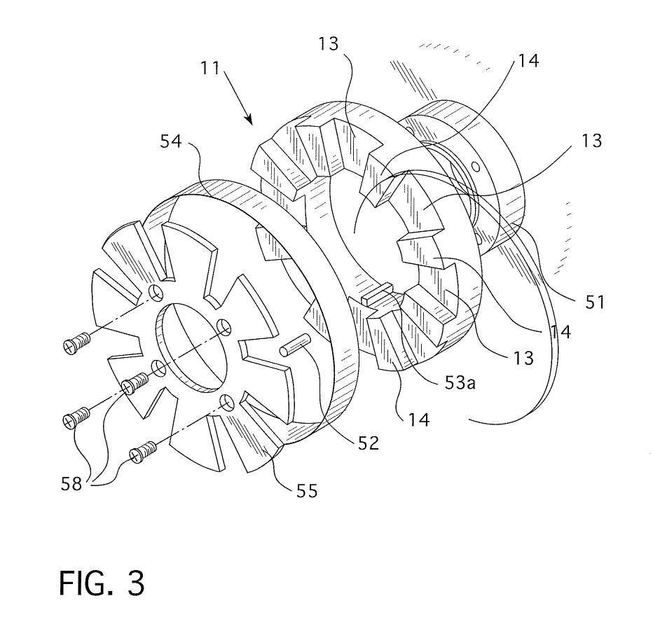

As shown in FIG. 1, cylindrical stator frame 20 comprises a number of stator support openings 21 to support stators members 25 (FIG. 2). The rotor assembly 22 (FIG. 3.) comprising rotors 11 is positioned along with similar assembly for rotor 10 within stator frame 20 with shaft 15 extending through opening 17 in end plate 18b into which opening bearing assembly 19 (FIG. 2) having bearings 19a and 19b (FIG. 1) supports drive shaft 15. A similar end plate 18a (FIG. 2.) having an opening 17 and bearing assembly 19a to support the rotor assembly within stator frame 20. Bolts 23 secure end plates 18 and 18a shown in FIG. 2 to the stator frame 20 and likewise bolts 24 secure bearing assemblies 19a and 19b to end plates 18 and 18a, FIG. 2, respectively.

FIG. 2 is a perspective view of motor 30 of the present invention showing a stator assembly 25 removed from the motor assembly. As can be seen, it is readily possible to remove a stator from the motor for field repair. Stator assembly in the present embodiment comprises twelve removable stators 25 which are mounted to the outside perimeter of openings 21. The actual number of stators will vary with the application configuration and size of the motor.

Referring to FIG. 2A, each removable stator assembly 25 comprises a stack of magnetically permeable laminations 31 and electrically conductive spiral windings 33 wrapped around permeable laminations 31. The winding 33 are a combination of the main magnetic flux producing windings and a small set flux density monitoring windings not shown. Laminations 31 are mounted to a finned heat sink 34 and retained by a clip 36 preferably using an adhesive. Openings 37 permit bolts, not shown, to affix the individual stators to stator assembly 20. A pair of lead wires 41 and their associated connectors are connected to main magnetic flux windings 33 of the stator, and form the basis to which the electrical drive necessary to produce magnetic flux within the stator. Leads 42 provide the connection to the flux density monitoring windings embedded within the magnetic flux producing windings 33. Leads 43 connect embedded temperature monitoring means within stack winding laminations 31.

As can be seen from FIG. 2, the stators are separate removable items and further, if one of the stators malfunctions, it is possible to continue operating the motor until the motor can be shut down and the faulty stator replaced. Most importantly, the motor continues to operate even if one or more stator cores fail. Such operation may cause the motor to consume more power to deliver the same mechanical output power, or it may operate at a lower mechanical output. Most importantly, the motor does not breakdown abruptly. For example, a three phase motor of the present invention will run continuously with the loss of one or two phases of drive current. Stator drive currents are continuously monitored and automatically adjusted by feedback control system to compensate for any lost drive phases.

Referring to FIG. 3, an exploded view of a rotor 11 is shown. The structure of rotor 11 includes a hub 51 onto which a spiral laminated wound rotor member is placed. Pin 52 is pressed into structural hub 51 and goes through the end lamination tang 53a of spiral wound laminated rotor which is constructed from a length of magnetically permeable material such as Hiperco or other highly permeable material and wrapped in a spiral manner. The resulting spiral was machined in order to form a number of salient poles 14 by means of cutting grooves 13 in the material. The number of poles 14 in this embodiment is eight, but any number may formed depending on the requirements of each individually configured machine. Spiral wound rotor is located on drive hub 51 and retaining band 54 is placed around the rotor to ensure integrity of said spirally wound, laminated rotor. Retaining plate 55 is placed over the face of the winding and secured with fasteners 58 to mate with structural hub 51. The purpose of the retaining plate 55 is to ensure lateral integrity to the winding of the spiral laminations.

In a preferred embodiment, each of the stator members includes a coil positioned parallel to the axis of rotation of the rotor. This motor also includes a detecting means for detecting the position of the rotor in relationship to the stator members. A control means is provided for receiving at least a first input from the rotor's rotation detecting means for controlling input into selected stator members in response to the detected signals produced by the detecting means. A control means also includes means for providing a current to at least one stator coil in response to a signal from the detecting means.

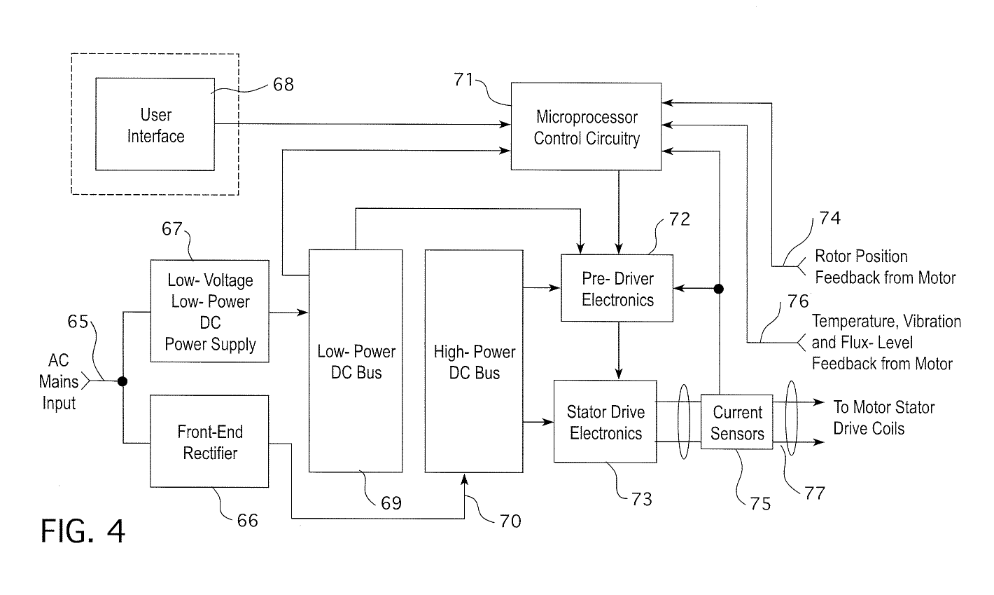

With reference to FIG. 4, a block diagram is shown for controlling the motors of the present invention. A primary AC connection 65 is provided to supply mains alternating current to the drive circuitry. The supplied current may be single phase alternating current or poly-phase alternating current depending on the configuration of the motor. Input AC power is rectified into direct current by means of rectifier 66, and low voltage low power DC power supply 67. Output of rectifier 66 is then used to power the internal high-power dc bus 70, while the output of the low-voltage low-power DC power supply 67 is used to power the low-power DC bus 69. The voltage level of the high-power DC bus 70 is governed by the desired operating parameters and wiring of the motor to be controlled. The low-power DC bus 69 then supplies rated power to the microprocessor control circuit 71. The microprocessor control circuit 71 provides for overall motor control by applying the appropriate drive signals to pre-driver electronic circuits 72, and by reconciling the feedback from the motor with the drive signals provided to the pre-driver electronic circuits 72. This feedback from the motor is (but not limited to) rotor positional feedback 74 as well as actual stator-drive current (via current sensors 75), and temperature, vibration, and magnetic-flux level feedback 76. The microprocessor control circuit 71 is commanded, via the user interface 68, which accepts controls from the user of the invention. User interface 68, may be part of the physical control means, may be a part of the physical control means separated by a distance, or may be embodied as a network interface. The output of the pre-driver electronic circuits 72, then drives the power electronic switching elements in the stator drive electronics 73. The purpose of the power electronic switching devices in the stator drive electronics 73 is to apply power from the high-power DC bus 70 to the stators of the motor in the proper sequence, with the proper on off time modulation as required by the given embodiment of the present invention. The number of output phases of the stator drive electronics 73 and pre driver electronics 72 are determined by the given configuration of present invention, but must be at least two or more. The output of the stator drive electronics 73 is sent to the stator coils of the motor via drive bus 77.

Alternatively the poly gap transverse circumferential flux machine may be configured using primary coils that produce commutation currents from counter-electromotive force (herein referred to as “CEMF”), which when directed through a circuit, such as an LC circuit, enhance the efficiency of the machine. These currents are switched on and off through a secondary set of stator coils without the need for these currents to be returned to the control system's intermediate DC bus. In another embodiment, an induced current passes within close proximity to the primary coils and directed to a power source and introduced into a set of secondary coils. The machine creates rotational torque as a direct result of rotor members being attracted to both primary and secondary stator members before commutation and repelled away from the stator coils as a consequence of the commutation event.

Referring to FIG. 5, motor 79 of the present invention is shown. Motor 79 is similar in construction to motor 30, but includes a centrally located rotor 80 mounted to shaft 85 concentrically with stator 90. Centrally positioned rotor 79 comprises a solid or laminated body having polar lobes 81a and 81b formed by annular groove 82 circumferentially around the assembly. A pair of secondary rotor plates 83 and 84 are secured to each opposing end of central rotor 80 and onto shaft 85. As shown in this embodiment, six modular, replaceable stators 90 are positioned circumferentially around a central rotor 80, between end plates 91, 92. along with two external rotors 83, 84. Each stator 90 is comprised of a highly permeable core material, such as stacked laminated electrical steel. Additionally, two pole pieces 94, 95 are shaped to mirror face areas of each rotor pole are fixed onto each end of each stator core and held into position by fixing bolt 114, first passing through end plate 91, then through first pole piece 95, through said core, then through opposing pole piece 94, then into opposing end plate 92. Fixing bolts 87 pass through end plate 91 then completely through tie block 112 and fixed into opposing end plate 92; thus securing the entire motor as an assembly 79. The embodiment of FIG. 5 provides enhanced power with control and discloses a number of possible configurations that can be utilized. The configuration shown in FIG. 5 provides stators 90 are juxta-positioned around rotors 80, 83 and 84 which are concentrically mounted. The embodiment shown in FIG. 5 provides the advantages of the motor described and shown in the inventors' motor disclosed in U.S. patent application Ser. No. 13/397,121, of which this application is a continuation in part.

While presently preferred embodiments of the invention have been shown and described, it may otherwise be embodied within the scope of the claims. As is customary, it will be understood that no limitation of the scope of the invention is thereby intended. The invention encompasses such alterations and further modifications in the illustrated apparatus, and such further applications of the principles of the invention illustrated herein, as would normally occur to persons skilled in the art to which the invention relates.

We claim:

1. An electric motor comprising
a. at least one annular stator assembly, said assembly comprising a plurality of independently removable stator elements, each stator element comprising at least one winding adapted for conducting a current to magnetize said element,
b. a shaft positioned along the axis of said stator assembly;
c. at least one rotor member positioned on said shaft juxtaposed with said annular stator assembly, said rotor comprising n rotor lobes, where n is greater than 1;
d. detecting means for detecting the position of said rotor in relationship to stator members; and
e. a control means for receiving at least a first input from said rotational detecting means for controlling input into selected stator members in response to said detecting means and including means for providing current to at least one stator coil in response to said detecting means.

2. An electrical machine set forth in claim 1 wherein at least a second rotor is positioned adjacent said stator member.

3. An electrical machine set forth in claim 1 wherein said stator is a removable cylindrical member having no back iron.

4. An electrical machine set forth in claim 1 wherein said rotor comprises a spiral wound lamination strip with notched areas which recede from the rotor face poles.

5. An electrical machine set forth in claim 1 wherein said rotor is comprised of pressed powdered metal.

6. An electrical machine set forth in claim 1 wherein said rotor is comprised of solid metal with permanent magnets attached as rotor faces.

7. An electrical machine set forth in claim 1 wherein said rotor is comprised of pressed powdered metal with permanent magnets attached as rotor faces.
